(19) United States
(12) Patent Application Publication
(10) Pub. No.: US 2026/0074174 A1
(43) Pub. Date: Mar. 12, 2026

(54) RETARDING FIELD ENERGY ANALYZER WITH MAGNETIC FILTER

(71) Applicant: Applied Materials, Inc., Santa Clara, CA (US)

(72) Inventors: SUHAS UMESH, Sunnyvale, CA (US); ANKE HELLMICH, Kahl (DE); AMIR BAYATI, San Jose, CA (US); CHRISTOPHER MALMS, Hanau (DE); LINDSAY HARDISON, Newport, NC (US)

(21) Appl. No.: 19/287,614

(22) Filed: Jul. 31, 2025

Related U.S. Application Data
(60) Provisional application No. 63/691,958, filed on Sep. 6, 2024.

(51) Int. Cl. H01J 49/48

(52) U.S. Cl. CPC H01J 49/488

(57) ABSTRACT

Embodiments described herein relate to an apparatus that includes a housing with an opening, and a plurality of grids within the housing that are arranged in a vertical stack. In an embodiment, a collector plate is provided below the plurality of grids within the housing, and a magnetic module is adjacent to the opening.

### CROSS-REFERENCE TO RELATED APPLICATIONS

This application claims the benefit of U.S. Provisional Application No. 63/691,958, filed on Sep. 6, 2024, the entire contents of which are hereby incorporated by reference herein.

### BACKGROUND

### 1) Field

Embodiments of the present disclosure pertain to the field of retarding field energy analyzer (RFEA) sensors with magnetic filters.

### 2) Description of Related Art

Plasma processing operations are used throughout the manufacture of semiconductor devices. However, monitoring the properties of the plasma is difficult. For example, properties, such as electron density, ion flux, and/or ion energy distribution are useful for determining the performance of a given processing operation. When plasma properties are well known for a given process, it is easier to optimize the process. Additionally, hardware performance can be optimized. For example, differences between a pulsing mode operation and a continuous mode waveform may be more accurately characterized.

Currently, plasma properties are determined through the use of devices such as a retarding field energy analyzer (RFEA). An RFEA includes a series of conductive screens that are applied in a stack. The screens are each held at different voltages in order to allow for ions with a specific energy to reach a collector plate. The current generated in the collector plate can be used to determine one or more of the plasma properties under investigation. However, during highly positive plasma conditions (e.g., during pulsed DC biasing), the ion flux measurement is unreliable because the screen responsible for repelling electrons is not capable of overcoming the bias. As such, electrons are able to pass through the grids and reach the collector plate. This alters the amount of current in the collector plate and makes the ion flux measurement inaccurate.

### SUMMARY

Embodiments described herein relate to an apparatus that includes a housing with an opening, and a plurality of grids within the housing that are arranged in a vertical stack. In an embodiment, a collector plate is provided below the plurality of grids within the housing, and a magnetic module is adjacent to the opening.

Embodiments described herein relate to an apparatus that includes a substrate, and a plurality of sensors spaced apart from each other on a surface of the substrate. In an embodiment, each of the plurality of sensors includes a housing with an opening, and a plurality of grids within the housing that are arranged in a vertical stack. In an embodiment, a collector plate is provided below the plurality of grids within the housing, and a magnetic module is adjacent to the opening.

Embodiments described herein relate to an apparatus that includes a housing with an opening, and a magnetic module adjacent to the opening. In an embodiment, a first grid is within the housing, where the first grid is configured to be held at a first voltage, and a second grid is within the housing, where the second grid is configured to be held at a second voltage. In an embodiment, a third grid is within the housing, where the third grid is configured to be held at a third voltage, and a fourth grid is within the housing, where the fourth grid is configured to be held at a fourth voltage. In an embodiment, a collector plate is within the housing, where the collector plate is configured to be held at a fifth voltage.

### BRIEF DESCRIPTION OF THE DRAWINGS

FIG. 1A is plan view illustration of a sensor device with a plurality of RFEA sensors distributed across a surface of the sensor device, in accordance with an embodiment.

FIG. 1B is a plan view illustration of an individual RFEA sensor, in accordance with an embodiment.

FIG. 2 is a cross-sectional illustration of an RFEA sensor with a highly positive plasma that allows for electrons to reach the collector plate, in accordance with an embodiment.

FIG. 3A is a cross-sectional illustration of an RFEA sensor with a magnetic module that produces a strong magnetic field over the opening in the housing, in accordance with an embodiment.

FIG. 3B is a cross-sectional illustration of the RFEA sensor with a highly positive plasma, where the magnetic module prevents electrons from entering the opening in the housing, in accordance with an embodiment.

FIG. 3C is a plan view illustration of an RFEA sensor with magnets on opposite edges of the opening in the housing, in accordance with an embodiment.

FIG. 3D is a plan view illustration of an RFEA sensor with a plurality of magnets around the edges of the opening in the housing, in accordance with an embodiment.

FIG. 3E is a plan view illustration of a sensor device with a plurality of RFEA sensors that include a magnetic module, in accordance with an embodiment.

FIG. 4A is a cross-sectional illustration of an RFEA sensor with magnets in a horizontal orientation for preventing electrons from entering an opening in the housing, in accordance with an embodiment.

FIG. 4B is a cross-sectional illustration of an RFEA sensor with magnets provided within the housing, in accordance with an embodiment.

FIG. 4C is a cross-sectional illustration of an RFEA sensor with magnets to prevent electrons from entering the housing and with a dedicated electron repulsion grid within the RFEA sensor omitted, in accordance with an embodiment.

FIG. 5 illustrates a block diagram of an exemplary computer system of a processing tool, in accordance with an embodiment of the present disclosure.

### DETAILED DESCRIPTION

Retarding field energy analyzer (RFEA) sensors with magnetic filters are disclosed herein, in accordance with various embodiments. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

As noted above, retarding field energy analyzers (RFEA) have issues providing reliable readings in some processing conditions. For example, during highly positive plasma conditions (e.g., during pulsed DC biasing), the ion flux measurement is unreliable because the screen responsible for repelling electrons is not capable of overcoming the bias. As such, electrons are able to pass through the grids and reach the collector plate. This alters the amount of current in the collector plate and makes the ion flux measurement inaccurate. In existing RFEAs, the screen for repelling electrons is biased at around −80V with respect to the housing. In a highly positive plasma condition, the bias would need to have a magnitude that is significantly higher. However, this would require extensive redesign of the electronic circuitry and/or power delivery for the RFEA.

Accordingly, embodiments disclosed herein include the generation of a strong magnetic field that can be used to trap electrons so they do not reach the collector plate even during highly positive plasma conditions. The magnetic field may be generated by the incorporation of a magnetic module adjacent to an opening in the housing. For example, the magnetic module may include a pair of magnets that are oriented so their magnetic poles are opposite from each other. This can be used to produce a strong magnetic field (e.g., a strong tangential and/or axial magnetic field relative to the opening) that is capable of trapping the electrons. In an embodiment, the magnets may be oriented so the magnetic poles are in a vertical orientation or a horizontal orientation. In some embodiments, the magnetic module may be mounted outside of the housing, or the magnetic module may be integrated inside of the housing. The strength of the magnetic field produced by the magnetic module may also be sufficient to completely remove the screen within the housing used to repel the electrons. As such, the construction and/or electronic design of the RFEA may be simplified.

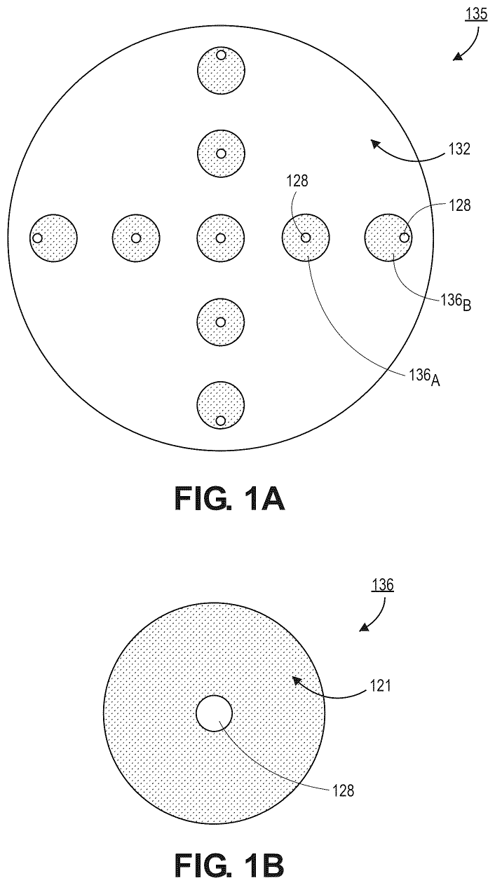

Referring now to FIG. 1A and FIG. 1B, a pair of plan view illustrations that show a sensor device 135 (FIG. 1A) and an individual sensors 136 (FIG. 1B) is shown, in accordance with an embodiment. FIG. 1A illustrates an example of how different sensor 136 layouts can be leveraged within a single senor device 135 for improved sensing coverage. FIG. 1B illustrates a single sensor 136 (e.g., an RFEA sensor 136) that may be integrated into the sensor device 135.

Referring now to FIG. 1A, a plan view illustration of a sensor device 135 is shown, in accordance with an embodiment. In an embodiment, the sensor device 135 may comprise a plurality of RFEA sensors 136 distributed across a lid 132 of the sensor device 135. The sensor device 135 may have a form factor similar to substrates that are processed within a plasma processing tool. For example, the sensor device 135 may have a wafer form factor (e.g., 200 mm, 300 mm, 450 mm, etc.), or a panel form factor.

The sensors 136 may include symmetric sensors 136_{A} and asymmetric sensors 136_{B}. The symmetric sensors 136_{A} may have an opening that is at a center of the symmetric sensors 136_{A}. The asymmetric sensors 136_{B} may have an opening that is at the outer edge of the asymmetric sensors 136_{B}. Further, the asymmetric sensors 136_{B} are oriented so that openings 128 are proximate to the outer edge of the lid 132. This allows for plasma properties to be sensed even closer to the edge of the sensor device 135. This is useful since edge effects are often difficult to control and predict, and having information about the plasma process proximate to the edge of a wafer can be particularly beneficial.

Referring now to FIG. 1B, a zoomed in plan view illustration of an individual RFEA sensor 136 is shown, in accordance with an embodiment. In an embodiment, the RFEA sensor 136 may comprise a housing 121. In an embodiment, an opening 128 may be provided through the housing 121 (e.g., through the top surface of the housing 121). In the illustrated embodiment, the opening 128 is positioned at a center point of the top surface of the housing 121. Such an RFEA sensor 136 may be referred to as a symmetric RFEA sensor 136. Though, the RFEA sensor 136 may also be asymmetric with the opening 128 provided off-center on the housing 121 (e.g., similar to the RFEA sensor 136_{B} shown in FIG. 1A). The opening 128 may provide a path to an interior of the RFEA sensor 136 that includes a plurality of electrically conductive plates (not shown) that have a grid of openings for allowing ions to pass through the interior of the RFEA sensor 136. The internal construction of the RFEA sensor 136 will be described in greater detail below.

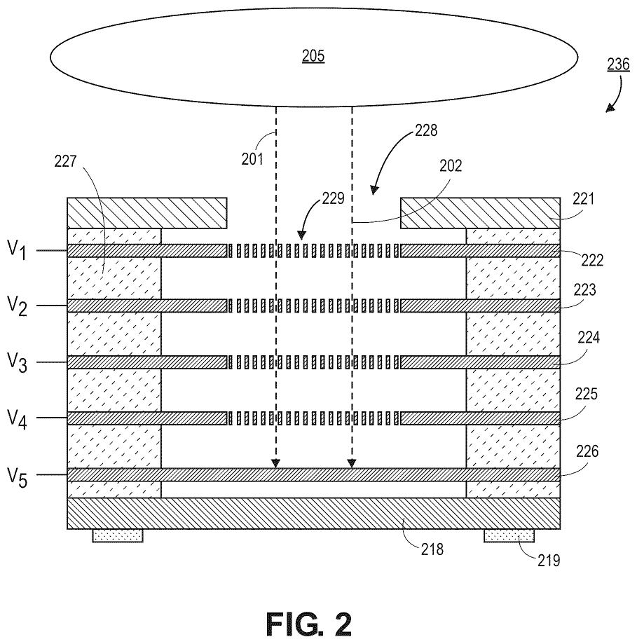

Referring now to FIG. 2, a cross-sectional illustration of an RFEA sensor 236 is shown, in accordance with various embodiments. The RFEA sensor 236 may comprise a housing 221 with one or more openings 228. In the illustrated embodiment, only a top portion of the housing 221 is shown for simplicity. Though, other embodiments may include a housing 221 that covers sidewalls and a backside surface of the RFEA sensor 236. The openings 228 may allow species from the plasma to pass into an interior of the RFEA sensor 236. In an embodiment, the interior of the RFEA sensor 236 may comprise a plurality of electrically conductive plates 222, 223, 224, and 225 that are arranged in a stack. The plates may each be held at different voltages V₁-V₄. In an embodiment, the conductive plates 222-2225 may each include a grid 229 to allow species to pass through the RFEA sensor 236. A collector plate 226 may be provided at a bottom of the plate stack, and the collector plate 226 may be held at a voltage V₅. The plates 222-225 and the collector plate 226 may be separated from each other by electrically insulating layers 227.

In an embodiment, the top plate 222 may be used to prevent plasma formation within the RFEA sensor 236. The next plate 223 may be an electron repulsion screen.

The plate 223 repels electrons by having a voltage V₂ that is negative. As noted above, the construction of the RFEA sensor 236 limits the magnitude of the voltage V₂ to approximately −80V. However, for highly positive plasmas 205, electrons (indicated by dashed line 202) have enough energy to overcome the repulsive force of the plate 223 and pass through the RFEA sensor 236 to the collector plate 226. As such, highly positive plasmas 205 force additional species (i.e., electrons) to reach the collector plate 226 and alter the amount of current induced in the collector plate 226. That is, the collector plate 226 no longer only generates current in response to ions 201 from the plasma 205 that pass through the RFEA sensor 236. This results in inaccurate readings of the ion flux since the effect of electrons cannot be isolated from the current measurement.

The next plate 224 may be a discriminator screen that controls the flow of species to the collector plate 226. In some embodiments, the third voltage V₃ may be scanned between a range in order to control the flow of ions through the RFEA sensor 236. For example, the scanning allows for ions of a particular energy to be detected by the RFEA sensor 236. The bottom plate 225 may be a secondary electron suppression screen. The voltage V₄ may be negatively biased with respect to the voltage V₅ of the collector plate 226 to create a retarding potential for repelling secondary electrons that are generated from the impact of ions with the collector plate 226. In an embodiment, ions that collide with the collector plate 226 induce a current in the collector plate 226. The current can be picked up by circuitry (not shown) of the RFEA sensor 236. The current can be correlated to the ion flux. In an embodiment, the collector plate 226 may be coupled to a board 218. The board 218 may include pads 219 that are coupled to the collector plate 226 by vias, traces, and/or the like (not shown). The pads 219 may be coupled to the sensor device (e.g. similar to sensor device 135 described in greater detail above).

As can be appreciated, new designs for an RFEA sensor are desired to further improve the ability to trap electrons so they do not enter the interior of the RFEA sensor so that the electrons do not reach the collector plate. Accordingly, embodiments disclosed herein may further include the integration of a magnetic module into the RFEA sensor.

The magnetic module can be used to generate a strong magnetic field that protects the opening of the housing. The magnetic field can trap the electrons before they enter the interior of the housing so that only ions reach the collector plate. As such, a more accurate reading of the ion flux is provided. Further, the use of a magnetic module allows for a simpler integration of the RFEA sensor since there is no need to redesign the electronics in order to provide a higher voltage for the second grid.

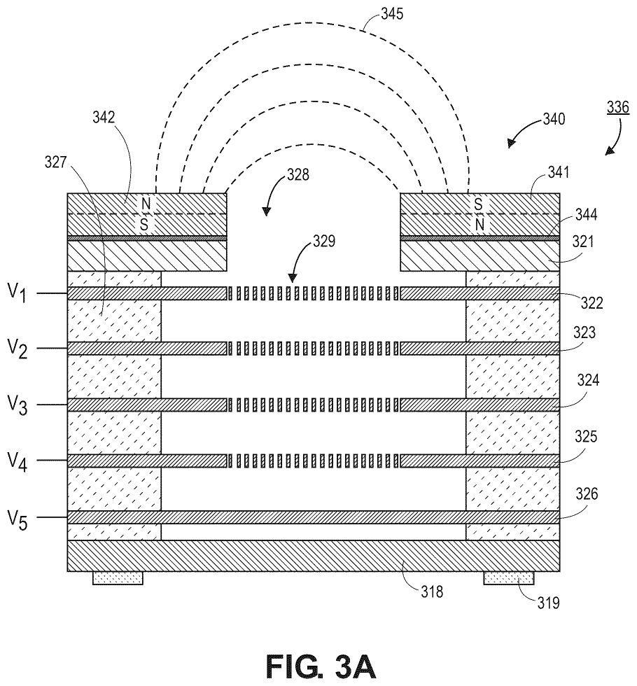

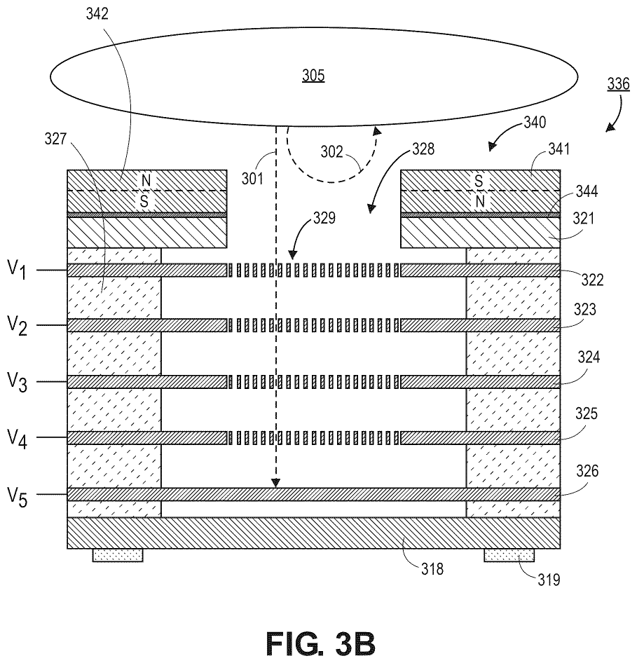

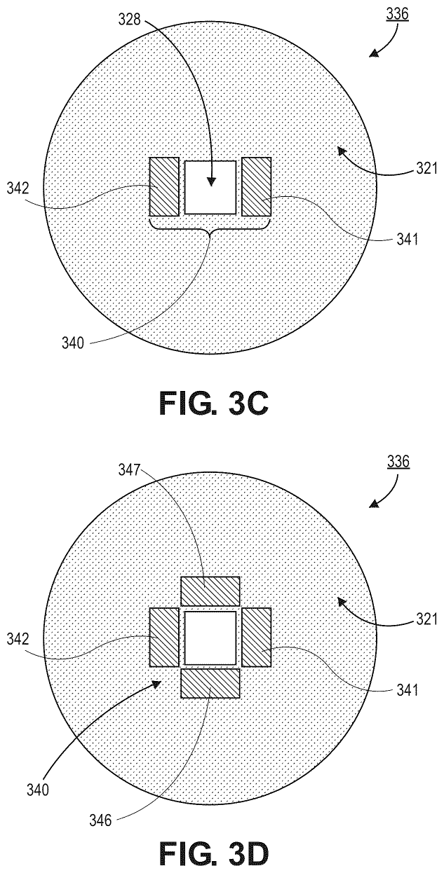

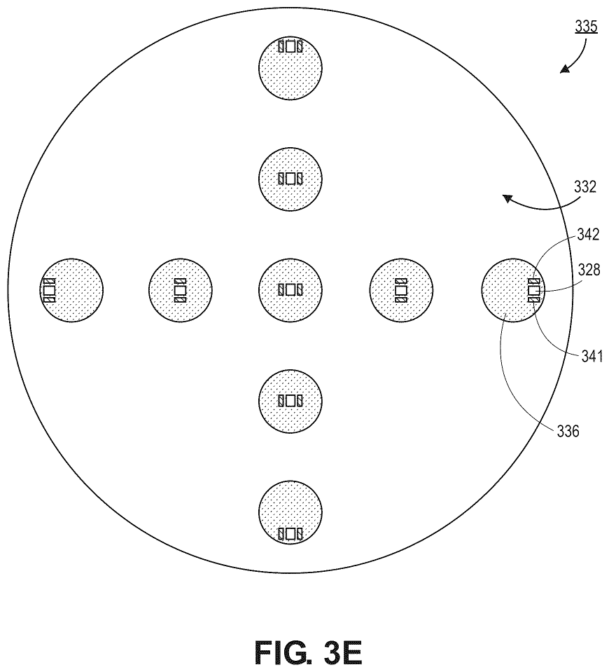

Referring now to FIG. 3A, a cross-sectional illustration of an RFEA sensor 336 is shown, in accordance with an embodiment. In an embodiment, the RFEA sensor 336 may be similar to the RFEA sensor 236 described above, with the addition of a magnetic module 340. For example, the RFEA sensor 336 may comprise a housing 321 that surrounds a plurality of conductive plates 322-325 (each with a grid 329) that are arranged in a stack above a collector plate 326. Insulating layers 327 may electrically isolate the conductive plates 322-325 and the collector plate 326 from each other. The collector plate 326 may be electrically coupled to a board 318 and pads 319.

In an embodiment, the housing 321 may comprise an opening 328 that allows species (not shown) to pass into the interior of the housing 321. The magnetic module 340 may be positioned adjacent to the opening 328. For example, the embodiment shown in FIG. 3A includes the magnetic module 340 being placed on the exterior surface of the housing 321 adjacent to the opening 328. In an embodiment, the magnetic module 340 may be coupled to the housing 321 using any suitable coupling mechanism. For example, an adhesive 344 is shown between the magnetic module 340 and the housing 321 in FIG. 3A. In other embodiments, the magnetic module 340 may be magnetically coupled to the housing 321. The magnetic module 340 may comprise a first magnet 341 and a second magnet 342. The first magnet 341 and the second magnet 342 may be provided on opposite edges of the opening 328.

In an embodiment, the first magnet 341 and the second magnet 342 may be oriented so that their magnetic poles are opposite from each other. For example, the first magnet 341 may have a north magnetic pole that faces toward the housing 321 and a south magnetic pole that faces away from the housing 321, and the second magnet 342 may have a south magnetic pole that faces toward the housing 321 and a north magnetic pole that faces away from the housing 321. Such an orientation with the magnetic poles facing towards the housing 321 or away from the housing 321 may be referred to as being vertically oriented herein. The opposite orientations of the first magnet 341 and the second magnet 342 may allow for the generation of a strong magnetic field 345 (indicated with dashed lines). The magnetic field 345 traps the negatively charged electrons from the plasma. In an embodiment, the strength of the magnetic field 345 may be high enough to trap electrons even in highly positive plasma environments. As shown, the magnetic field 345 may span across the opening 328.

In an embodiment, the magnetic module 340 may comprise relatively strong magnetic materials. Further the magnetic materials may also comprise materials with a relatively high Curie temperature to allow for integration in processing environments with high processing temperatures. For example, the Curie temperature of the magnetic module 340 may be approximately 200° C. or higher, approximately 500° C. or higher, or approximately 700° C. or higher. In a particular embodiment, the magnetic module 340 may be a permanent magnet, such as one that comprises a Samarian cobalt material.

Referring now to FIG. 3B, a cross-sectional illustration of an RFEA sensor 336 with a magnetic module 340 during operation is shown, in accordance with an embodiment. In an embodiment, the magnetic module 340 may include a first magnet 341 and a second magnet 342 that are vertically oriented with opposite magnetic pole orientations. In FIG. 3B, the magnetic field lines are omitted for simplicity. In FIG. 3B, a highly positive plasma 305 is provided above the RFEA sensor 336. Ions (indicated with dashed line 301) from the plasma 305 are allowed to pass through the opening 328 and reach the collector plate 326. However, electrons (indicated with dashed line 302) are trapped so that they do not enter the opening 328 by the magnetic field generated by the magnetic module 340. As such, the electrons are not permitted to reach the collector plate 326. This allows for the current induced in the collector plate 326 to be correlated to only the ion flux of the plasma 305. Accordingly, more accurate readings of the ion flux can be provided.

Referring now to FIGS. 3C and 3D, a pair of plan view illustrations of different RFEA sensors 336 configurations are shown, in accordance with various embodiments. In FIG. 3C, the magnetic module 340 comprises a first magnet 341 and a second magnet 342 that are provided on opposite edges of the opening 328 through the housing 321. In the illustrated embodiment, the first magnet 341 and the second magnet 342 are rectangular. Though, it is to be appreciated that the first magnet 341 and the second magnet 342 may be any suitable shape. The first magnet 341 may have a first orientation and the second magnet 342 may have a second orientation. The first orientation and the second orientation may include magnetic poles that are opposites of each other. For example, the first magnet 341 may have a north magnetic pole facing away from the housing 321, and the second magnet 342 may have a north magnetic pole facing towards the housing 321. Though, the magnets 341 and 342 may also have horizontal orientations (which will be described in greater detail herein).

In FIG. 3D, the magnetic module 340 comprises a plurality of magnets 341, 342, 346, and 347. That is, magnets may be provided adjacent to multiple edges of the opening 328. In the embodiment shown in FIG. 3D, the first magnet 341 and a third magnet 346 may be in a first orientation, and the second magnet 342 and a fourth magnet 347 may be in a second orientation. The first orientation and the second orientation may include magnetic poles that are opposites of each other. For example, the first magnet 341 may have a north magnetic pole facing away from the housing 321, and the second magnet 342 may have a north magnetic pole facing towards the housing 321. Though, the magnets 341, 342, 346, and 347 may also have horizontal orientations (which will be described in greater detail herein).

Referring now to FIG. 3E, a plan view illustration of a sensor device 335 is shown, in accordance with an embodiment. The sensor device 335 may be similar to the sensor device 135 described herein, with the addition of magnetic modules to each of the RFEA sensors 336. In an embodiment, the sensor device 335 may comprise a plurality of RFEA sensors 336 distributed across a lid 332 of the sensor device 335. The sensor device 335 may have a form factor similar to substrates that are processed within a plasma processing tool. For example, the sensor device 335 may have a wafer form factor (e.g., 200 mm, 300 mm, 450 mm, etc.), or a panel form factor.

In an embodiment, the individual RFEA sensors 336 may have symmetric setups or asymmetric setups (with respect to the positioning of the openings 328) in order to provide greater edge-to-edge detection of ion flux. In the embodiment shown in FIG. 3E, each of the RFEA sensors 336 have a design similar to the RFEA sensor 336 shown in FIG. 3C. Though, it is to be appreciated that the magnetic module may comprise more magnets than the first magnet 341 and the second magnet 342 shown in FIG. 3E.

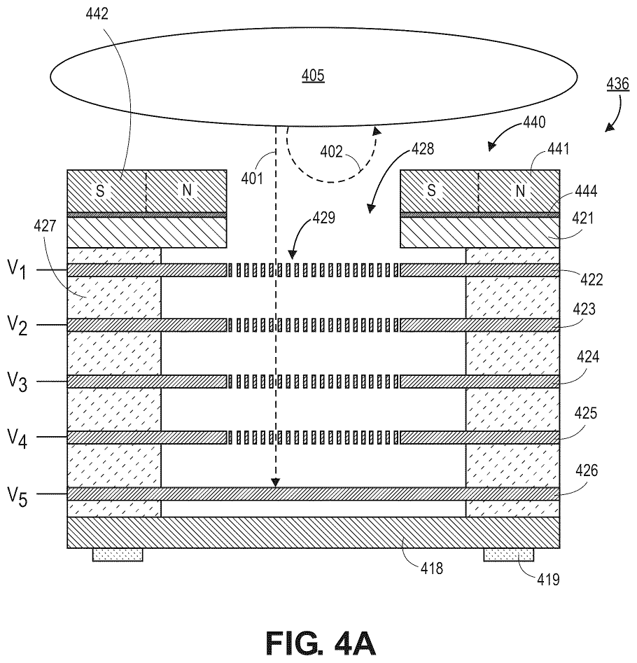

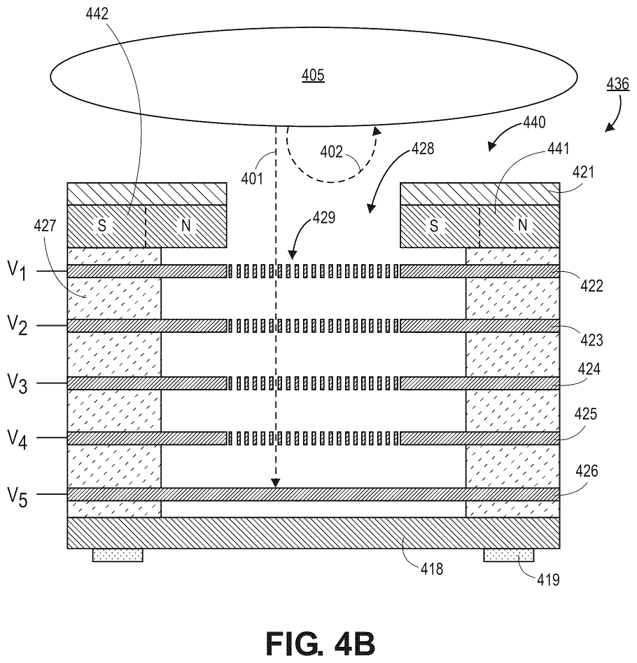

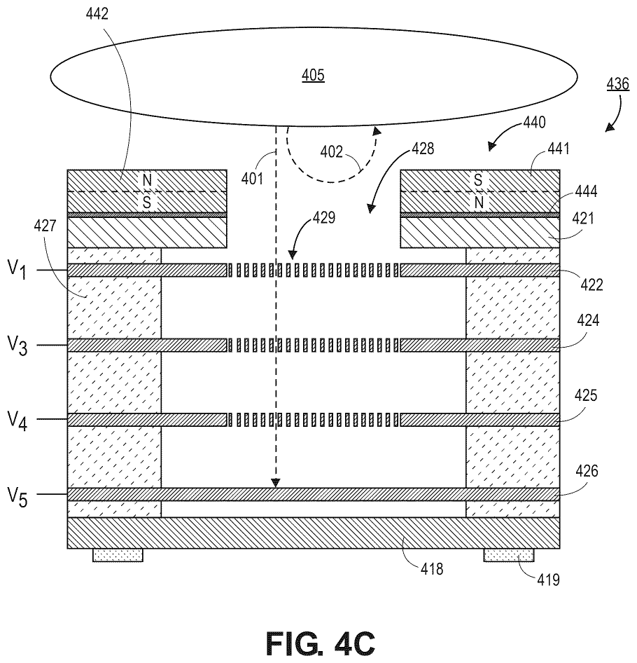

Referring now to FIG. 4A-4C, a series of cross-sectional illustrations depicting a plurality of different RFEA sensor 436 configurations are shown, in accordance with additional embodiments.

Referring now to FIG. 4A, a cross-sectional illustration of an RFEA sensor 436 with a magnetic module 440 that comprises a horizontally oriented first magnet 341 and a horizontally oriented second magnet 342 is shown, in accordance with an embodiment. In an embodiment, the RFEA sensor 436 may be substantially similar to the RFEA sensor 336 shown in FIG. 3B, with the exception of the orientation of the magnetic module 440. For example, the RFEA sensor 436 may comprise a housing 421 that surrounds a plurality of conductive plates 422-425 (each with a grid 429) that are arranged in a stack above a collector plate 426. Insulating layers 427 may electrically isolate the conductive plates 422-425 and the collector plate 426 from each other. The collector plate 426 may be electrically coupled to a board 418 and pads 419.

In an embodiment, the housing 421 may comprise an opening 428 that allows species (not shown) to pass into the interior of the housing 421. The magnetic module 440 may be positioned adjacent to the opening 428. For example, the embodiment shown in FIG. 4A includes the magnetic module 440 being placed on the exterior surface of the housing 421 adjacent to the opening 428. In an embodiment, the magnetic module 440 may be coupled to the housing 421 using any suitable coupling mechanism. For example, an adhesive 444 is shown between the magnetic module 440 and the housing 421 in FIG. 4A. In other embodiments, the magnetic module 440 may be magnetically coupled to the housing 421. The magnetic module 440 may comprise a first magnet 441 and a second magnet 442. The first magnet 441 and the second magnet 442 may be provided on opposite edges of the opening 428.

In contrast to FIG. 3B, the first magnet 441 and the second magnet 442 are arranged in a horizontal configuration. That is, the magnetic poles of the first magnet 441 and the second magnet 442 may face towards the opening 428 or away from the opening 428. The first magnet 441 may be oppositely oriented relative to the second magnet 442. For example, the first magnet 441 may have a north magnetic pole that faces away from the opening 428 and a south magnetic pole that faces towards the opening, and the second magnet 442 may have a north magnetic pole that faces the opening 428 and a south magnetic pole that faces away from the opening 428. The opposite orientation of the first magnet 441 and the second magnet 442 allows for the generation of a strong magnetic field that traps electrons from the plasma 405 (indicated by dashed line 402) so they do not enter opening 428 while ions from the plasma 405 (indicated by dashed line 401) are allowed to pass through the opening 428 and continue to the collector plate 426.

Referring now to FIG. 4B, a cross-sectional illustration of an RFEA sensor 436 is shown, in accordance with another embodiment. In an embodiment, the RFEA sensor 436 in FIG. 4B is similar to the RFEA sensor 436 in FIG. 4A, with the exception of the location of the magnetic module 440. Instead of being outside of the housing 421, the magnetic module 440 is within the housing 421. For example, the magnetic module 440 (e.g., the first magnet 441 and the second magnet 442) may be provided between the housing 421 and the first conductive plate 422. In the illustrated embodiment, the magnetic module 440 is oriented with a horizontal orientation for the magnetic poles. However, embodiments may also comprise a magnetic module 440 that includes a vertical orientation for the magnetic poles within the housing 421.

Referring now to FIG. 4C, a cross-sectional illustration of an RFEA sensor 436 is shown, in accordance with yet another embodiment. In an embodiment, the RFEA sensor 436 in FIG. 4C is similar to the RFEA sensor 336 in FIG. 3B, with the exception of the number of conductive plates within the housing 421. Particularly, the RFEA sensor 436 in FIG. 4C may omit the conductive plate used to repel electrons. That is, the conductive plate between conductive plates 422 and 424 may be omitted. The conductive plate used to repel electrons may be omitted since the magnetic module 440 may sufficiently trap electrons and prevent the electrons from entering the RFEA sensor 436. Since substantially no electrons enter the opening 428 due to the strong magnetic field, the inclusion of a dedicated conductive plate for repelling electrons may not be necessary.

Removal of the conductive plate used to repel electrons may have several benefits. First, the removal may simplify the design (e.g., circuit design, power deliver design, etc.) of the RFEA sensor 436. Second the removal of components within the RFEA sensor 436 may reduce the cost of the bill of materials and/or reduce the assembly cost and/or complexity. Additionally, the removal of the electron repulsion conductive plate may allow for a reduction in a thickness of the RFEA sensor 436.

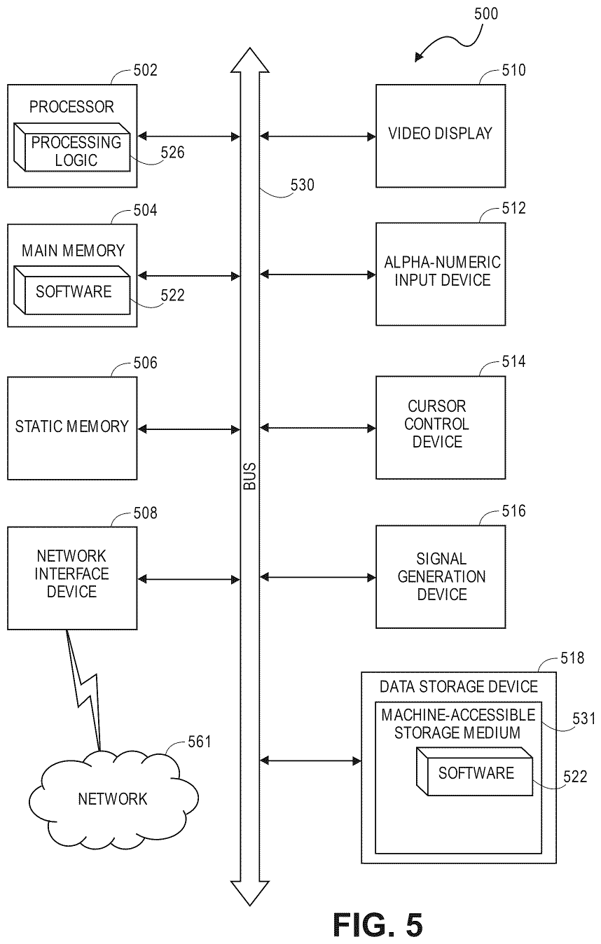

Referring now to FIG. 5, a block diagram of an exemplary computer system 500 of a processing tool is illustrated in accordance with an embodiment. In an embodiment, computer system 500 is coupled to and controls processing in the processing tool, such as semiconductor processing that is monitored by a sensor device similar to any of those described in greater detail herein.

Computer system 500 may be connected (e.g., networked) to other machines in a Local Area Network (LAN), an intranet, an extranet, or the Internet. Computer system 500 may operate in the capacity of a server or a client machine in a client-server network environment, or as a peer machine in a peer-to-peer (or distributed) network environment. Computer system 500 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 500, the term “machine” shall also be taken to include any collection of machines (e.g., computers) that individually or jointly execute a set (or multiple sets) of instructions to perform any one or more of the methodologies described herein.

Computer system 500 may include a computer program product, or software 522, having a non-transitory machine-readable medium having stored thereon instructions, which may be used to program computer system 500 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 500 includes a system processor 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a secondary memory 518 (e.g., a data storage device), which communicate with each other via a bus 530.

System processor 502 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 502 may also be one or more special-purpose processing devices such as an application specific integrated circuit (ASIC), a field programmable gate array (FPGA), a digital signal system processor (DSP), network system processor, or the like. System processor 502 is configured to execute the processing logic 526 for performing the operations described herein.

The computer system 500 may further include a system network interface device 508 for communicating with other devices or machines. The computer system 500 may also include a video display unit 510 (e.g., a liquid crystal display (LCD), a light emitting diode display (LED), or a cathode ray tube (CRT)), an alphanumeric input device 512 (e.g., a keyboard), a cursor control device 514 (e.g., a mouse), and a signal generation device 516 (e.g., a speaker).

The secondary memory 518 may include a machine-accessible storage medium 531 (or more specifically a computer-readable storage medium) on which is stored one or more sets of instructions (e.g., software 522) embodying any one or more of the methodologies or functions described herein. The software 522 may also reside, completely or at least partially, within the main memory 504 and/or within the system processor 502 during execution thereof by the computer system 500, the main memory 504 and the system processor 502 also constituting machine-readable storage media. The software 522 may further be transmitted or received over a network 561 via the system network interface device 508. In an embodiment, the network interface device 508 may operate using RF coupling, optical coupling, acoustic coupling, or inductive coupling.

While the machine-accessible storage medium 531 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

Thus, embodiments of the present disclosure retarding field energy analyzer (RFEA) sensors with magnetic filters.

The above description of illustrated implementations of embodiments of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

What is claimed is:

1. An apparatus, comprising:
a housing with an opening;
a plurality of grids within the housing that are arranged in a vertical stack;
a collector plate below the plurality of grids within the housing; and
a magnetic module adjacent to the opening.

2. The apparatus of claim 1, wherein the magnetic module comprises a first magnet adjacent to a first edge of the opening and a second magnet adjacent to a second edge of the opening opposite from the first edge.

3. The apparatus of claim 2, wherein the first magnet is oriented with a first north pole facing away from the housing and a first south pole facing towards the housing, and wherein the second magnet is oriented with a second south pole facing away from the housing and a second north pole facing towards the housing.

4. The apparatus of claim 2, wherein the first magnet is oriented with a first north pole facing away from the opening and a first south pole facing towards the opening, and wherein the second magnet is oriented with a second south pole facing away from the opening and a second north pole facing towards the opening.

5. The apparatus of claim 1, wherein the magnetic module is outside of the housing.

6. The apparatus of claim 1, wherein the magnetic module is within the housing.

7. The apparatus of claim 1, wherein the magnetic module comprises four or more magnets.

8. The apparatus of claim 1, wherein the magnetic module comprises permanent magnets with a Curie temperature of 200° C. or higher.

9. The apparatus of claim 8, wherein the permanent magnets comprise a Samarian cobalt material.

10. The apparatus of claim 1, wherein the opening is off-center on a top surface of the housing.

11. An apparatus, comprising:
a substrate; and
a plurality of sensors spaced apart from each other on a surface of the substrate, wherein each of the plurality of sensors comprises:
a housing with an opening;
a plurality of grids within the housing that are arranged in a vertical stack;
a collector plate below the plurality of grids within the housing; and
a magnetic module adjacent to the opening.

12. The apparatus of claim 11, wherein the magnetic module comprises a first magnet and a second magnet.

13. The apparatus of claim 12, wherein first poles of the first magnet are oriented opposite from second poles of the second magnet.

14. The apparatus of claim 12, wherein the first magnet and the second magnet are oriented so that magnetic poles are horizontally oriented.

15. The apparatus of claim 12, wherein the first magnet and the second magnet are oriented so that magnetic poles are vertically oriented.

16. The apparatus of claim 12, wherein the first magnet and the second magnet are oriented so that magnetic poles are horizontally oriented.

17. The apparatus of claim 11, wherein the plurality of grids comprises three grids.

18. An apparatus, comprising:
a housing with an opening;
a magnetic module adjacent to the opening;
a first grid within the housing, wherein the first grid is configured to be held at a first voltage;
a second grid within the housing, wherein the second grid is configured to be held at a second voltage;
a third grid within the housing, wherein the third grid is configured to be held at a third voltage;
a fourth grid within the housing, wherein the fourth grid is configured to be held at a fourth voltage; and
a collector plate within the housing, wherein the collector plate is configured to be held at a fifth voltage.

19. The apparatus of claim 18, wherein the second voltage is a first negative bias, wherein the third voltage is configured to be scanned over a range of voltages, wherein the fourth voltage is a second negative bias, and wherein the fifth voltage is a third negative bias.

20. The apparatus of claim 18, wherein the magnetic module comprises a first magnet and a second magnet that are oriented with magnetic poles in opposite directions.
